(19) United States
(12) Patent Application Publication
(10) Pub. No.: US 2006/0207301 A1
(43) Pub. Date: Sep. 21, 2006

(54) Interlocked double-unlockable lock apparatus

(76) Inventor: Chun-Te Yu, Fu-Hsing Hsiang (TW)

Correspondence Address: BRUCE H. TROXELL, SUITE 1404, 5205 LEESBURG PIKE, FALLS CHURCH, VA, 22041, US

(21) Appl. No.: 11/081,522

(22) Filed: Mar. 17, 2005

(51) Int. Cl. E05B 73/00

(52) U.S. Cl. 70/58; 70/284; 70/285

(57) ABSTRACT

An interlocked double-unlockable lock apparatus including at least two unlocking modules. The unlocking modules are able to independently unlock the lock apparatus. The unlocking modules are at least partially interlocked with each other in a locked state. When any of the unlocking modules is unlocked, the two unlocking modules are released from each other to unlock the lock apparatus.

### BACKGROUND OF THE INVENTION

The present invention is related to an interlocked double-unlockable lock apparatus which is a division of fore-application Ser. No. 10/792,875. The lock apparatus includes two unlocking modules interlocked with each other.

The conventional locking apparatuses include numeral system and key-driven system. The numeral system includes numeral wheel type and press key type. These locking apparatuses are widely applied to various fields. For example, Taiwanese Patent No. 369068, entitled “hanging lock structure” and Taiwanese Patent No. 498918, entitled “hanging lock structure (5)” disclose locks pertaining to key-driven system. Taiwanese Patent No. 32470, entitled “numeral lock of baggage case or suitcase” and Taiwanese Patent No. 46563, entitled “adjustable numeral lock of suitcase” disclose locks pertaining to numeral system.

Practically, after the baggage case or suitcase is locked and transferred to a destination, it often takes place that a user misses the key or forgets to bring the key or forgets the unlocking number and cannot open the baggage case or suitcase. Under such circumstance, it is necessary to ask a locksmith to unlock or even break the lock for opening the baggage case or suitcase.

In another condition, for ensuring security in international navigation, in more and more customs, the customs workers are authorized to forcedly break off the lock of the baggage case or suitcase and open the same for checking the contents. This can prevent restrained articles from illegally passing through the customs. However, the damage of the lock of the baggage case or suitcase is a loss to a user and will lead to trouble and inconvenience to the user.

In order to improve the above situation, more and more customs have regulated that the lock manufacturers must provide a standard key for the customs for opening all the locks manufactured by the manufacturers. According to this regulation, there are several lock manufacturers all over the world who are allowed to manufacture such locks.

It is therefore tried by the applicant to provide a locking apparatus which meets the regulation of the customs. In case a user forgets to bring the unlocking tool or forgets the unlocking number, the locking apparatus provides another unlocking measure for the user.

According to the above, various double-unlockable lock apparatuses have developed. These double-unlockable lock apparatuses are commercially available. However, in the structure design of all these lock apparatuses, two independent unlocking modules are disposed in one single lock apparatus. Therefore, it is necessary to prepare two sets of unlocking measures adapted to the two unlocking modules. Such design is quite complicated and the lock apparatus will have large volume and heavy weight. Also, the cost for such lock apparatus is relatively high.

### SUMMARY OF THE INVENTION

It is therefore a primary object of the present invention to provide a double-unlockable lock apparatus. The lock apparatus includes two unlocking modules which are at least partially interlocked with each other in a locked state. When any of the unlocking modules is unlocked, the two unlocking modules are unlocked from each other. The structure of the double-unlockable lock apparatus is simplified so as to minify the volume thereof.

The present invention can be best understood through the following description and accompanying drawings wherein:

### BRIEF DESCRIPTION OF THE DRAWINGS

FIG. 1 is a perspective assembled view of a preferred embodiment of the present invention;

FIG. 2 is a perspective view of the present invention, showing that the male fastener is unlatched from the female fastener;

FIG. 3 is a perspective exploded view of the female fastener of the present invention;

FIG. 4 is a perspective partially explode view of the female fastener according to FIG. 3;

FIG. 5 is a sectional view showing that the numeral unlocking unit of the present invention is in a locked state with the male and female fasteners latched with each other;

FIG. 6 is a sectional view showing that the numeral unlocking unit of the present invention is in an unlocked state with the male and female fasteners unlatched from each other;

FIG. 7 is a sectional view showing that the key-unlocked unit of the present invention is in a locked state with the male and female fasteners latched with each other;

FIG. 8 is a sectional view-showing that the key-unlocked unit of the present invention is in an unlocked state with the male and female fasteners unlatched from each other;

FIG. 9 is a perspective exploded view of another embodiment of the present invention, showing another type of key-unlocked unit;

FIG. 10 is a perspective exploded view according to FIG. 9, in which the key-unlocked unit is in a locked state;

FIG. 11 is a perspective exploded view according to FIG. 9, in which the key-unlocked unit is in an unlocked state;

FIG. 12 is a perspective exploded view of another embodiment of the present invention;

FIG. 13 is a perspective assembled view according to FIG. 12;

FIG. 13A is an enlarged view of circled area A of FIG. 13;

FIG. 14 is a side sectional assembled view of the embodiment of FIG. 12 in a locked state;

FIG. 15 shows the locking/unlocking operation of the numeral unlocking unit of the embodiment of FIG. 12;

FIG. 16 shows the unlocking operation of the key-unlocked unit of the embodiment of FIG. 12;

FIG. 16A is a sectional view taken along line A-A of FIG. 16;

FIG. 16B is a sectional view taken along line B-B of FIG. 16;

FIG. 17 shows the unlocking operation of the key-unlocked unit of the embodiment of FIG. 12;

FIG. 18 is a sectional view of still another embodiment of the present invention in a locked state;

FIG. 19 shows the unlocking operation of the key-unlocked unit of the embodiment of FIG. 12;

FIG. 20 is a perspective exploded view of still another embodiment of the present invention, which is applied to a hanging lock;

FIG. 21A is a partially sectional assembled view of the embodiment of FIG. 20;

FIG. 21B is a view according to FIG. 21A, showing the unlocking operation of the numeral locking unit of the embodiment of FIG. 20; and

FIGS. 21C and 21D show the unlocking operation of the key-unlocked unit of the embodiment of FIG. 20.

### DETAILED DESCRIPTION OF THE PREFERRED EMBODIMENTS

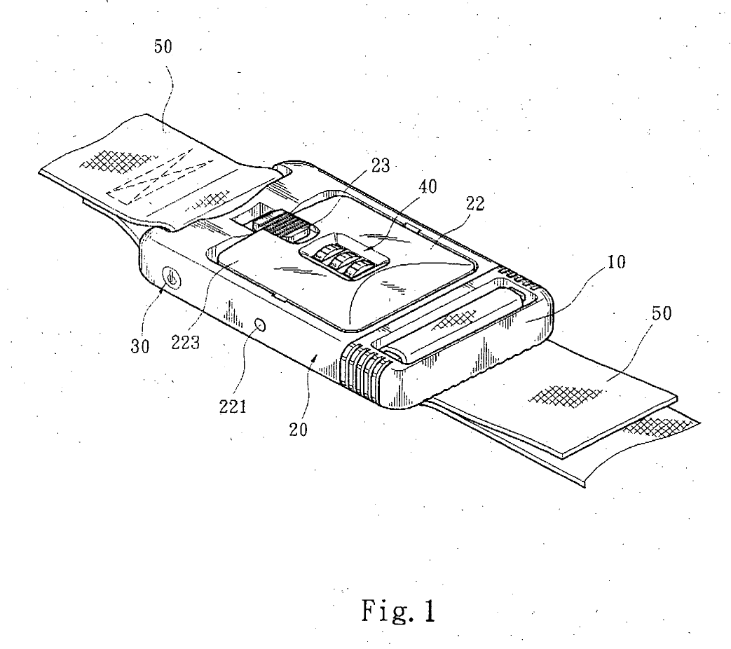

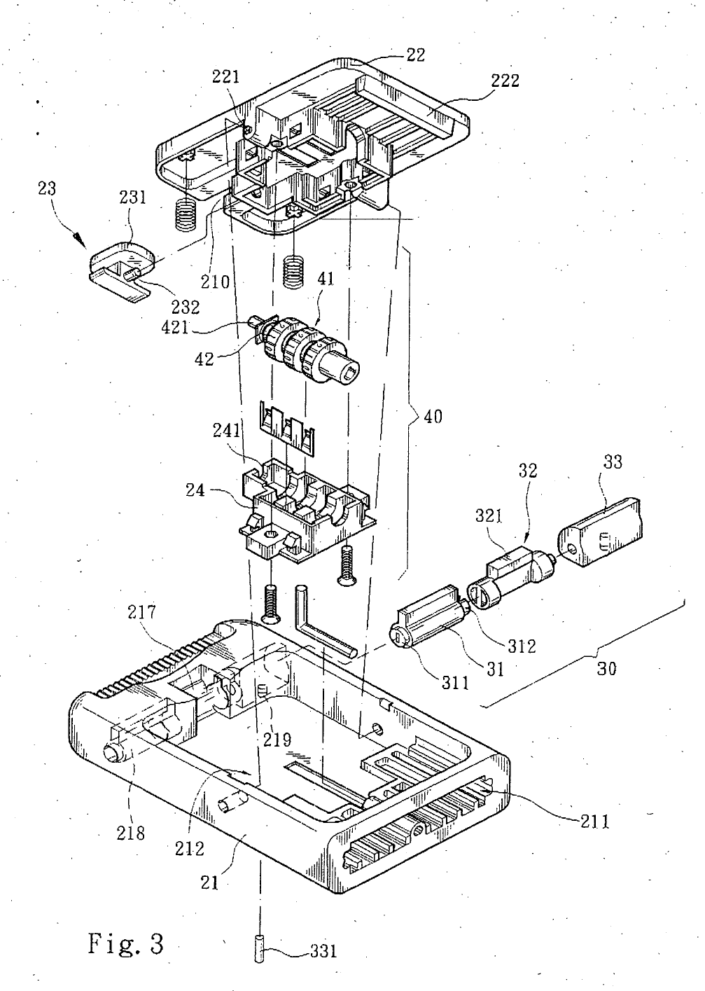

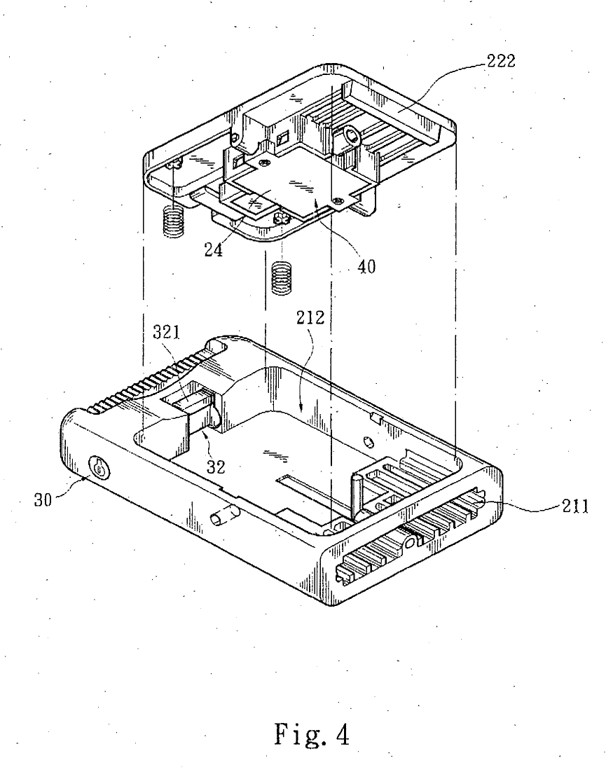

Please refer to FIGS. 1 to 8. According to a first embodiment the lock of the present invention is a woven strap lock composed of a male fastener 10 and a female fastener 20. One end of the male fastener 10 is looped by a fastening strap 50. The other end of the male fastener 10 has an insertion tongue 11 which can be inserted into the female fastener 20.

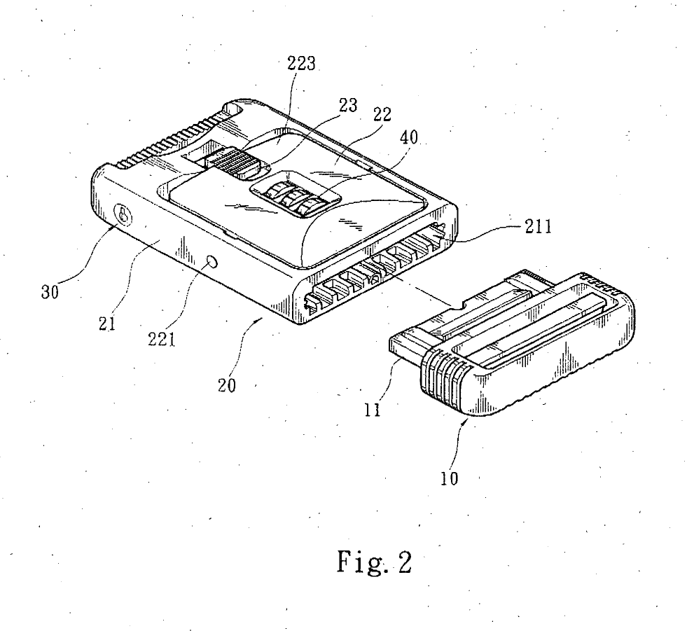

Referring to FIGS. 2 to 4, the female fastener 20 is composed of a seat body 21 and a teeterboard type latch plate 22 pivotally connected with the seat body 21. A key-unlocked unit 30 is disposed in a non-insertion end of the seat body 21. The other end of the seat body is formed with an insertion opening 211 corresponding to the insertion tongue 11 of the male fastener 10. In addition, the seat body 21 is recessed to form an operation room 212 communicating with the insertion opening 211. The latch plate 22 is mounted at the operation room 212.

Two projecting shafts 221 are disposed on two sides of the latch plate 22 near a middle section thereof for pivotally connecting with two sides of the operation room 212 of the seat body 21. Accordingly, the latch plate 22 can be teetered back and forth within the operation room 212. A numeral unlocking unit 40 is disposed on inner face of the latch plate 22. One end of the latch plate 22 is formed with an engaging edge 222 corresponding to the inserted male fastener 10. When the insertion tongue 11 is inserted into the insertion opening 211, the engaging edge 222 is latched with the insertion tongue 11. The other end of the latch plate is a press end 223 which can be pressed to lift the end with the engaging edge 222 so as to unlatch the Insertion tongue 11. A displaceable member 23 (that is, locking member) is disposed at the press end 223. The displaceable member 23 is controlled by the numeral unlocking unit 40 to be displaceable or not.

The key-unlocked unit 30 is composed of a lock core seat 31, a support member 32 and a locating block 33. The lock core seat is fitted in a receptacle 218 of the seat body 21. An outer end of the lock core seat is formed with a key hole 311. An inner end of the lock core seat has a lock core 312 coupled with one end of the support member 32 for controlling the support member 32 to rotate. A support section 321 projects from the support member 32, whereby when the support member 32 is rotated, the support section 321 can enter a locking position to stop lower side of the displaceable member 23 or enter an unlocking position to release the displaceable member 23. The support member 32 is arranged in a dent 217 of the seat body 21. The other end of the support member is pivotally connected with the locating block 33. The locating block 33 is fixed in another receptacle 219 of the seat body 21 by a fixing member 331.

The numeral unlocking unit 40 is composed of a numeral wheel set 41 and a driving rod 42 driven and controlled by the numeral wheel set 41. The driving rod 42 is resiliently extensibly fitted in the numeral wheel set 41. A press end 421 of the driving rod 42 resiliently extends out from a hole 241 of the lock casing 24. The displaceable member 23 of the latch plate 22 touches the press end 421 to control unlocking/locking thereof.

The press end 223 of the latch plate 22 is formed with a push slot 210 in which the displaceable member 23 is slidably disposed. The displaceable member 23 has a push plate 231. In natural state, a rear section of the push plate 231 can be resiliently pushed to engage on the support section 321 of the support member 32. The displaceable member 23 has an abutting post 232 extending toward the numeral unlocking unit 24.

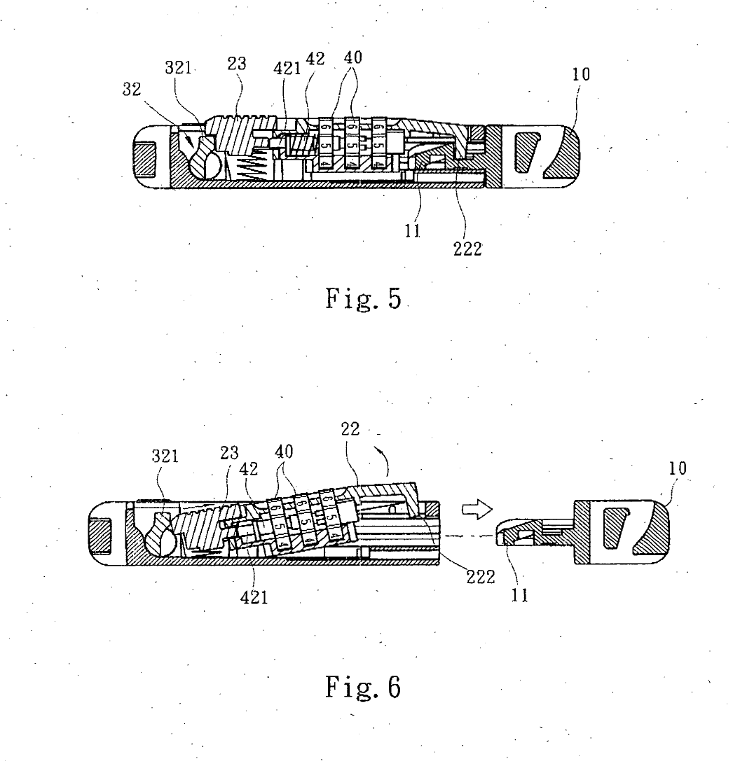

Referring to FIGS. 5 and 6, when the numeral unlocking unit 40 is in an unlocked state, the latch plate 22 can push the displaceable member 23 to disengage from the support section 321. At this time, the press end 223 can be pressed to make the other end with the engaging edge 222 turn upward and unlatch from the insertion tongue 11. The displaceable member 23 can be directly pushed by a finger toward the numeral unlocking unit 40 to disengage the rear section of the push plate 231 from the support section 321. Then the press end 223 of the latch plate 22 is pressed down to unlatch from the latch hook edge 111.

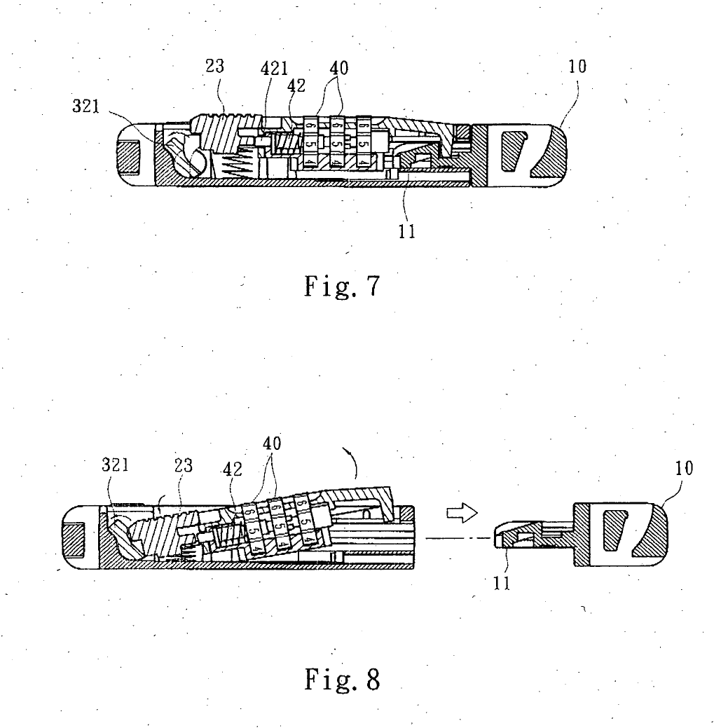

Referring to FIGS. 7 and 8, when a key is inserted into the keyhole 311 of the key-unlocked unit 30 and turned to an unlocked state, the support section 321 of the support member 32 is turned and no more engaged with lower side of the displaceable member 23. Therefore, there is a sufficient space for pressing down the press end 223 into the seat body 21. At this time, the other end with the engaging edge 222 is turned upward and unlatched from the insertion tongue 11.

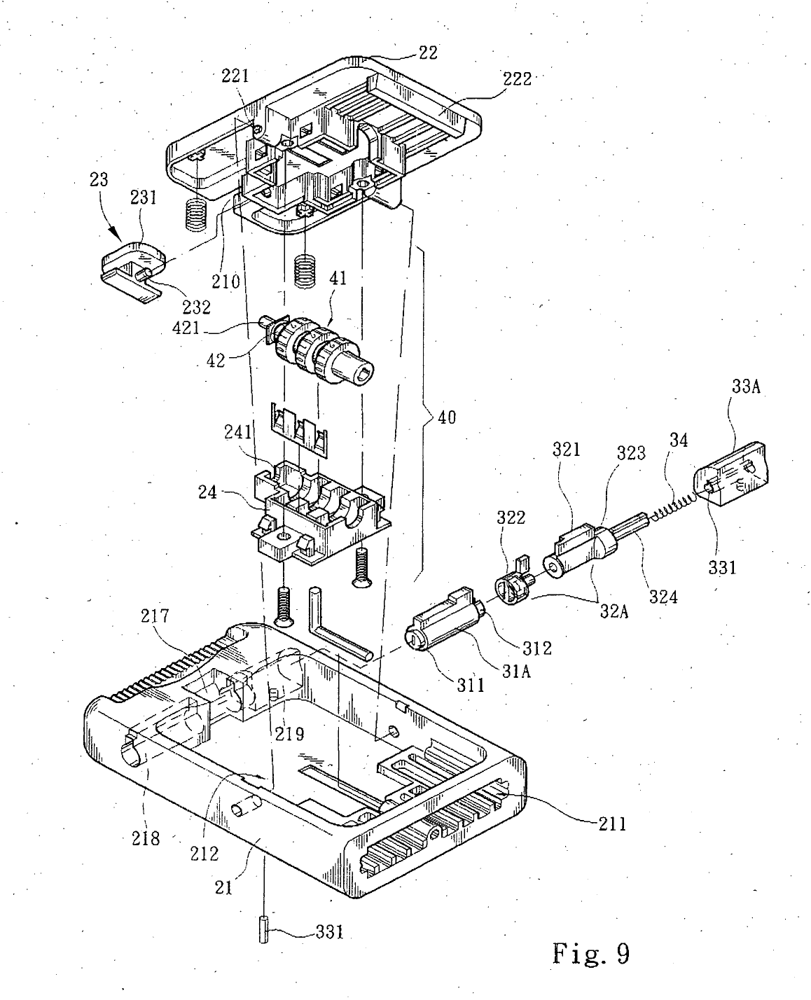

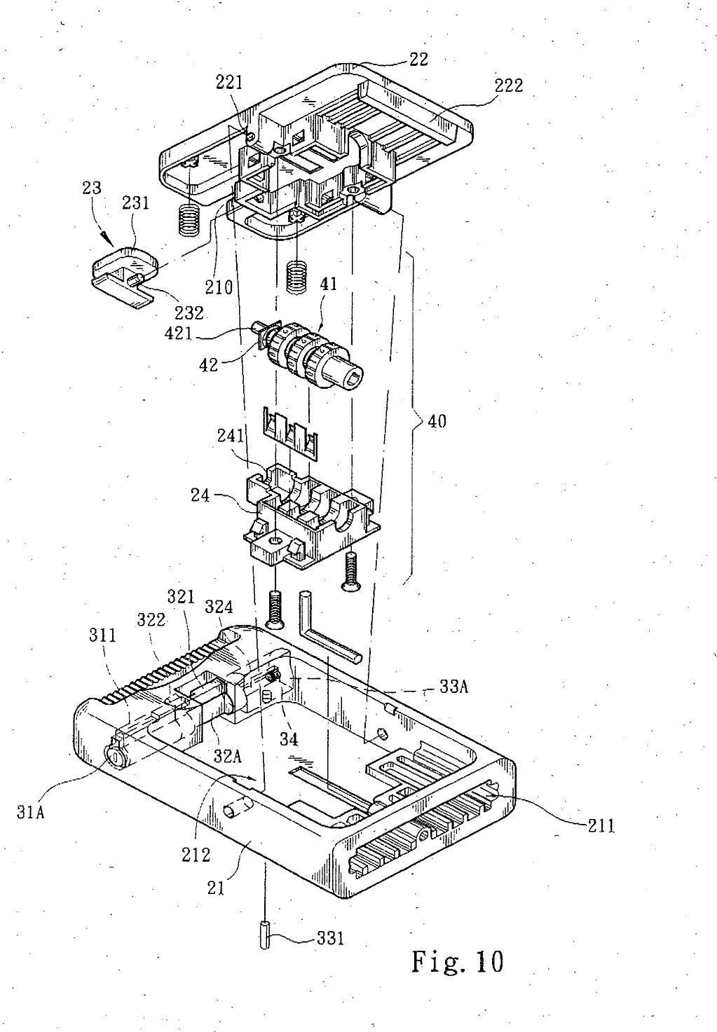

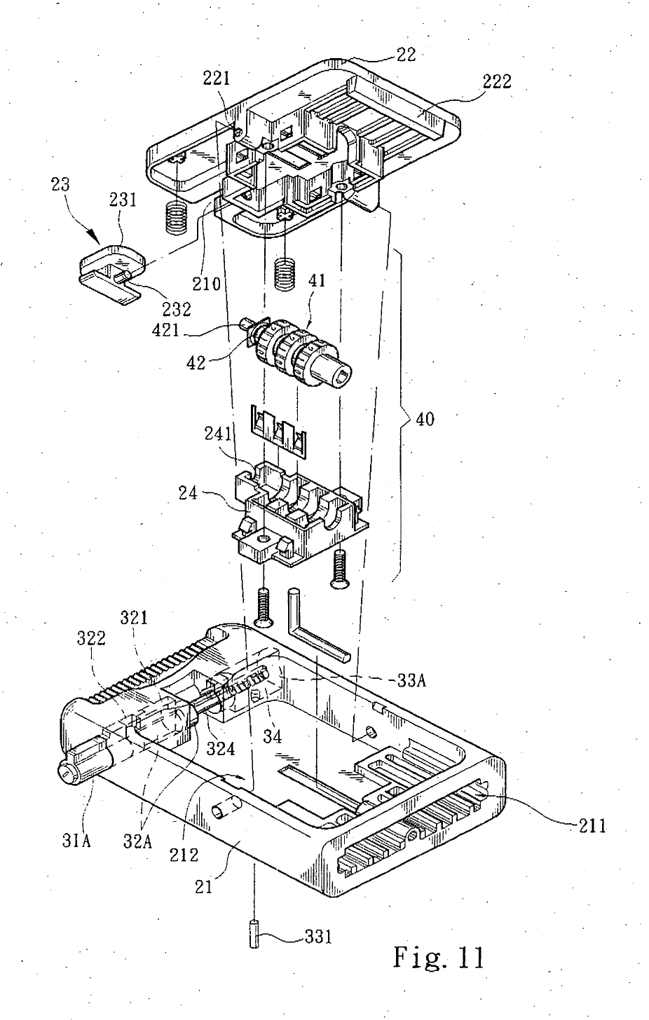

FIGS. 9 to 11 show a second embodiment of the present invention, which is derived from the first embodiment. In the second embodiment, not only the key-unlocked unit 30 can be disengaged from the latch plate 22 by way of rotation, but also the lock core seat 31 can be axially drawn away from the engaged position. The key-unlocked unit can be alternatively composed of a lock core seat 31A, a support member 32A and a locating block 33A. The support member 32A is divided into a rotatable section 322 and a straight shift section 323 which is pivotally fitted with the rotatable section 322. One end of the straight shift section 323 is formed with a straight shift shaft 324 which is inserted in an extensible hole 331 of the locating block 33A. A resilient member 34 is disposed in the extensible hole 331 for resiliently pushing the straight shift shaft 324. In addition, the support member 32A has a support section 321 extending to the push button 23. One end of the rotatable section 322 is pivotally fitted in the straight shift section 321. The other end of the rotatable section 322 is coupled with inner end of the lock core 312 and rotatable therewith. The lock core seat 31A is mounted in the receptacle 218 of the seat body 21. The receptacle 218 is formed with a space allowing the lock core seat 31A to be axially outward drawn. Accordingly, in an unlocked state, the lock core seat 31A can be straightly shifted within the space. Reversely, in a locked state, the lock core seat is fixed in the space and cannot be straightly shifted. When the lock core seat is straightly shifted, the support member 32A can be straightly shifted to disengage from the push button 23.

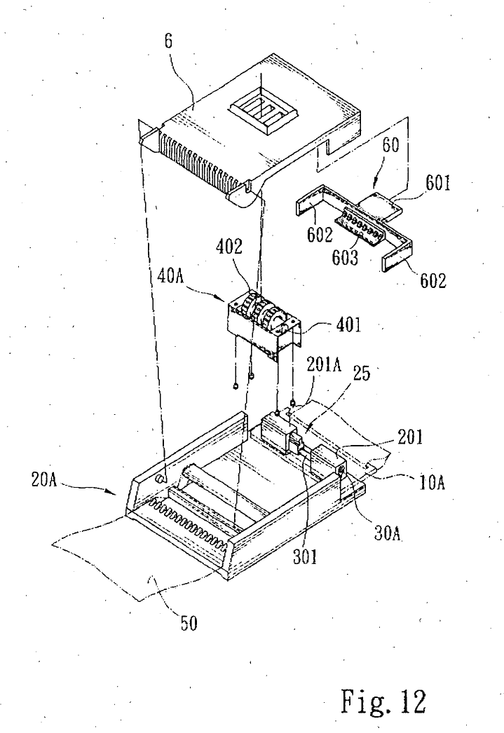

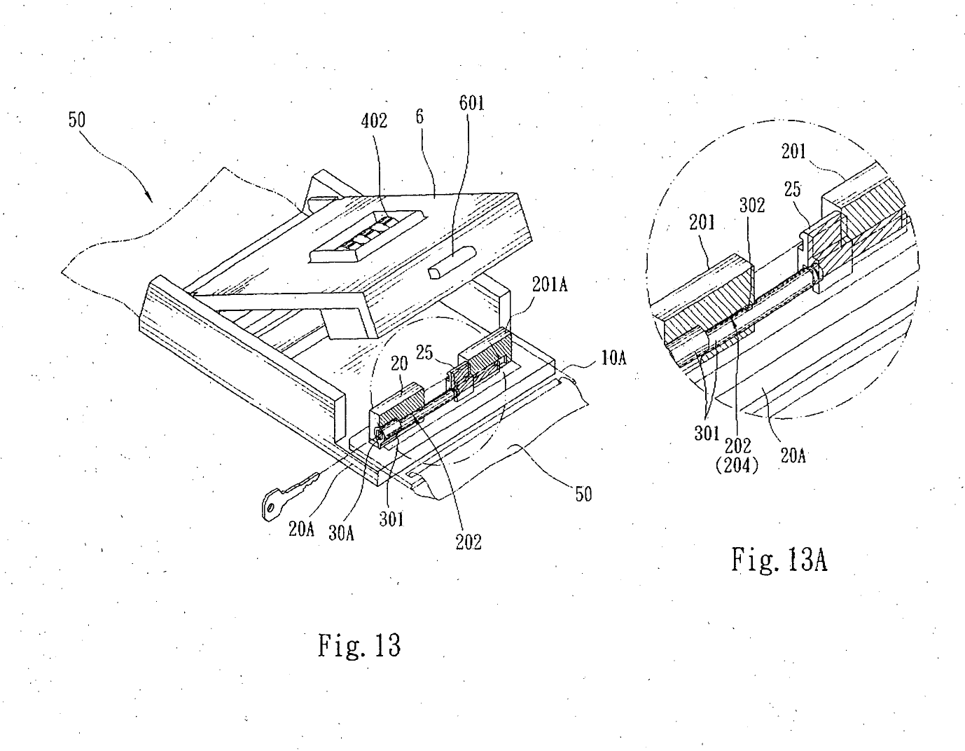

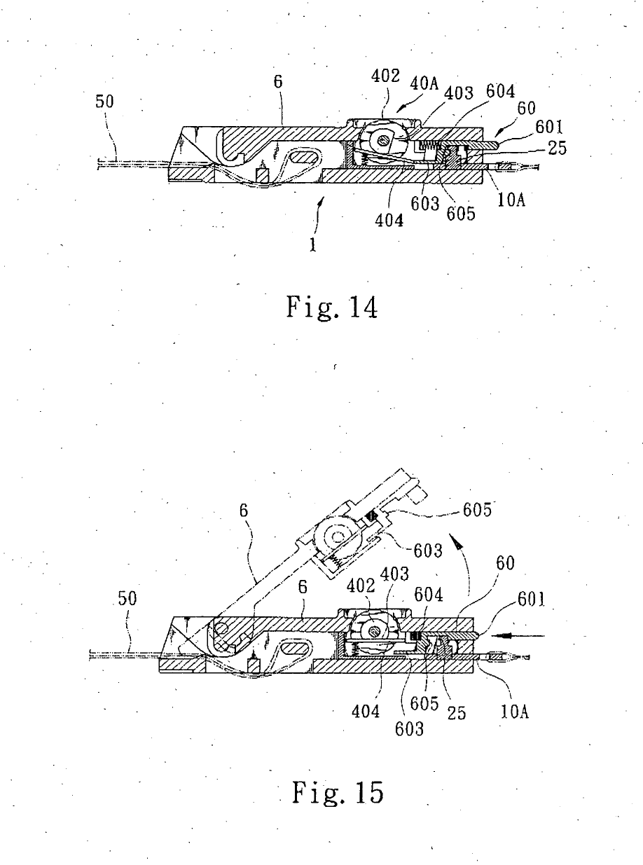

Please refer to FIGS. 12 and 13A which respectively are perspective exploded view and assembled view of a second embodiment of the present invention. Also referring to FIG. 14 which is a side sectional assembled view of the embodiment in a locked state, the second embodiment includes a male fastener 10A, a female fastener 20A, a key-unlocked unit 30A, a numeral unlocking unit 40A, a latch cover 6 and a button member 60. A front edge of the female fastener 20A is formed with projecting latch hook seats 201, 201A for fitting with the male fastener 10A. A displacement range is disposed near or between the latch hook seats 201, 201A. A lower latch hook 25 is received in the displacement range. The lower latch hook 25 is transversely connected with the key-unlocked unit 30A near a lateral side of the latch hook seats 201, 201A. A lock core 301 drivable by a key extends through a lock core hole 202 into the displacement range for driving the lower latch hook 25. The numeral unlocking unit 40A includes a wheel shaft 401 and multiple numeral wheels 402 rotatably fitted on the wheel shaft 401. Each numeral wheel 402 has a plane cut face 403 to which a stopper board 404 can resiliently attach. One end of the latch cover 6 is pivotally connected with the female fastener 20A. The other end of the latch cover 6 is formed with a through hole 62. A press end 601 of the button member 60 protrudes through the through hole 62 from the latch cover 6. The button member 60 includes a pair of sideboards 602 with a U-shape. The press end 601 outward extends from a section between the two sideboards 602. An inward extending section 603 inward extends from the section between the two sideboards 602. A resilient member 604 is compressed between the female fastener 20A and the button member 60. In normal state, the button member 60 is forced forward to fit with front end of the latch cover 6. The inward extending section 603 extends to one side of the numeral unlocking unit 40A. In locked state, the rear end of the stopper board 404 of the numeral unlocking unit 40A stops the inward extending section 603 from inward moving. Under such circumstance, the button member 60 cannot be pushed inward. An upper latch hook 605 is formed on the middle of the button member 60 and extends toward the lower latch hook 25. In normal state, the upper latch hook 605 is hooked with the lower latch hook 25 of the female fastener 20A, whereby the latch cover 6 is kept locked with the female fastener 20A. Under such circumstance, the male fastener 10A cannot be disengaged from the latch hook seats 201, 201A so as to achieve a locking effect.

FIG. 15 shows the unlocking operation of the numeral unlocking unit 40A of the third embodiment. When the numeral wheels 402 are turned to a correct position (number), the plane cut faces 403 are flush with the top face of the stopper board 404. The stopper board 404 is moved away from the position where the inward extending section 603 is stopped. At this time, the button member 60 can be pressed to compress the resilient member 604 and make the upper latch hook 605 of the button member 60 disengaged from the lower latch hook 25. Under such circumstance, the latch cover 6 can be turned upward and the male fastener 10A can be disengaged from the latch hook seats 201, 201A and unlocked.

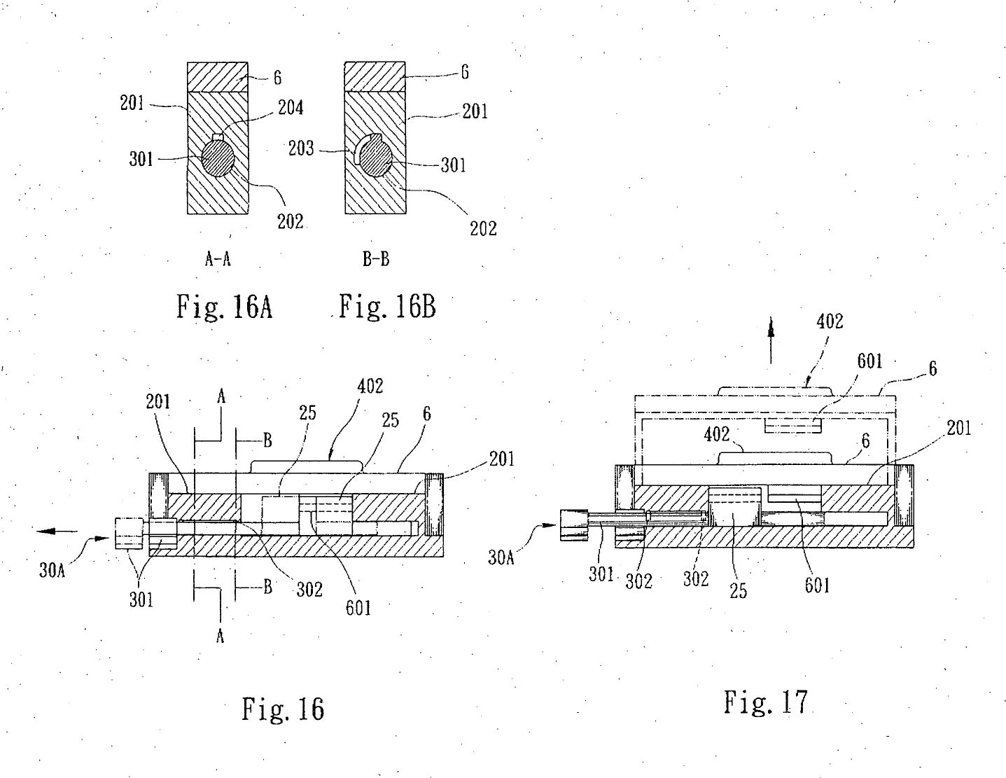

FIGS. 16 and 17 show the unlocking operation of the key-unlocked unit 30A of the third embodiment of the present invention. Also referring to FIGS. 16A and 16B, the center of a lateral face of the latch hook seat 201 is transversely formed with a lock core through hole 202 in which the lock core 301 is received. On end of the lock core hole 202 has a sector notch 203 near the displacement range. A channel 204 extends from the sector notch 203 toward the other end. A middle section of the lock core 301 is formed with a perpendicularly extending projecting block 302. When the projecting block 302 is rotated within the sector notch 203 to a position not aligned with the channel 204, the lock core 301 cannot be axially outward drawn out. In normal state, the upper latch hook 605 of the button member 60 is resiliently pushed by the resilient member 604 to keep hooking with the lower latch hook 25. At this time, the male fastener 10A fastened with the female fastener 20A is pressed by the latch cover 6 in a locked state. When the lock core 301 is driven and rotated by an inserted key, the projecting block 302 is rotated to a position (true unlocking position) aligned with the channel 204. At this time, the lock core 301 can be outward slid along the lock core-hole 202 (with the projecting block 302 sliding within the channel 204). The lower latch hook 25 is driven to transversely move and unlatch from the upper latch hook 605. Under such circumstance, the latch cover 6 is released and can be turned upward; whereby the male fastener 10A is unlocked.

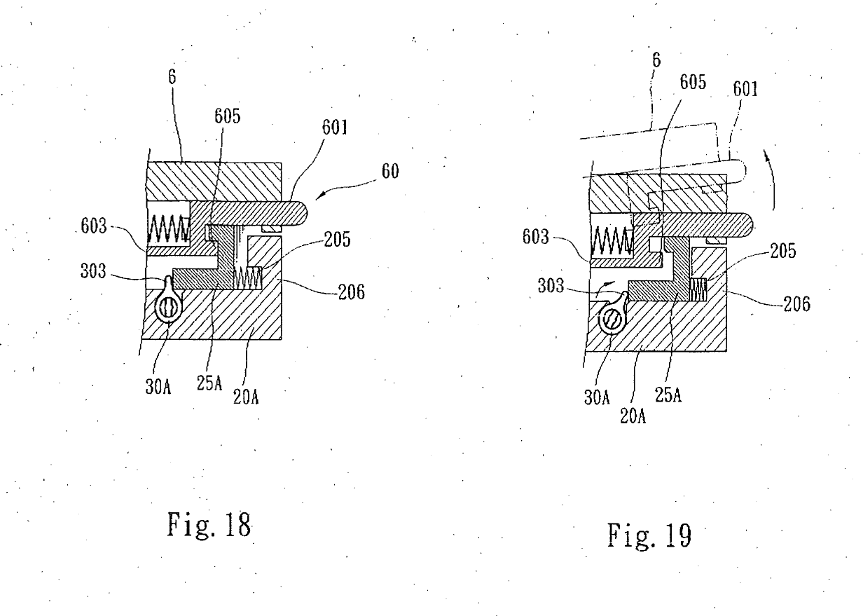

FIGS. 18 and 19 show another embodiment derived from the embodiments of FIGS. 13 to 18. In this embodiment, the lower latch hook 25A is disposed in a displaceable range between the latch hook seats 201, 201A. A projecting section 303 drivable by the lock core 301 abuts against the lower latch hook 25A. A resilient member 205 is compressed between the lower latch hook 25A and a stopper section 206 projecting from the female fastener 20A. The resilient member 205 resiliently pushes the lower latch hook 25A to keep the lower latch book 25A tightly hooked with the upper latch hook 605. Under such circumstance, the latch cover 6 is locked. When a key is inserted into the lock core 301 to drive and rotate the projecting section 303, the lower latch hook 25A is pushed away and disengaged from the upper latch hook 605 (with the resilient member 205 compressed). Under such circumstance, the latch cover 6 can be turned upward to unlock the male fastener.

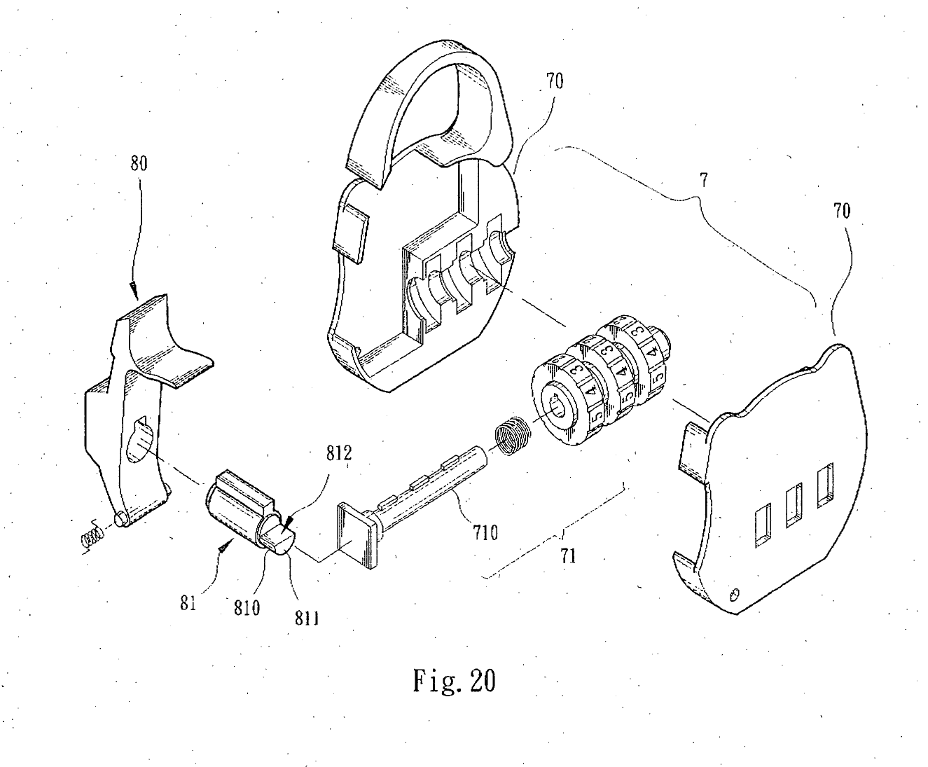

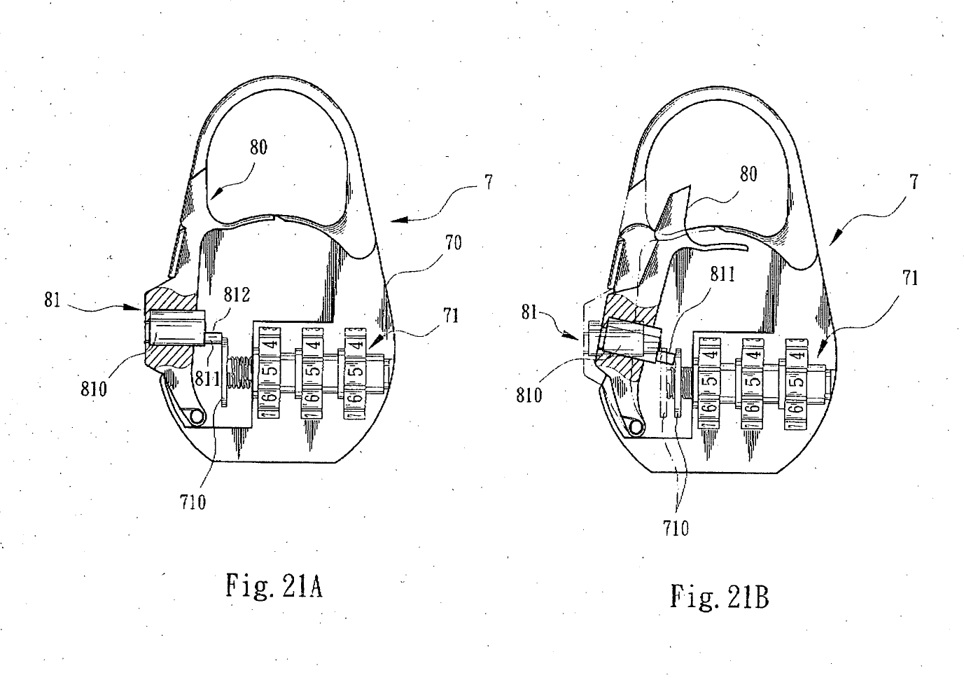

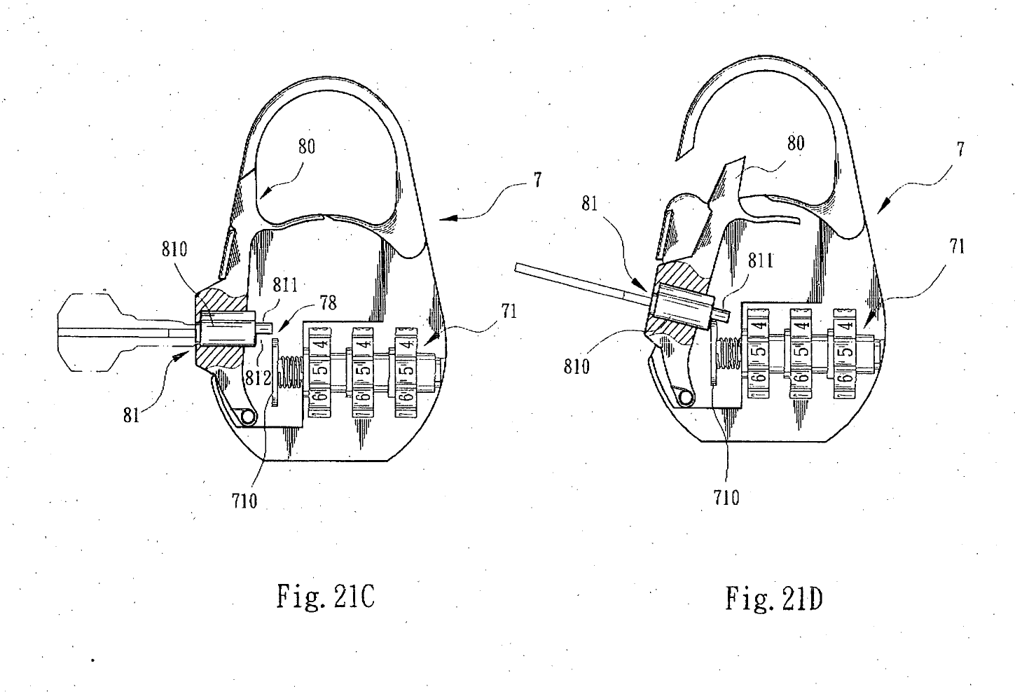

Please refer to FIGS. 20 to 21D. The above embodiment is applicable to a hanging lock 7. The hanging lock 7 has a housing 70 and a movable hook 80 pivotally disposed on the housing 70. A numeral unlocking unit 71 is installed in the housing 70. A key-unlocked unit 81 is disposed on the movable hook 80. The movable hook 80 is movable relative to the housing 70 to form an unlocked state or, a locked state. The numeral unlocking unit 71 has a driving rod 710 extending toward the movable hook 80. The key-unlocked unit 81 has a movable lock core 810 extending toward the driving rod 710 in reverse direction. In a locked state of the movable hook 80, a rear end 811 of the movable lock core 810 just touches the driving rod 710. Besides, the rear end 811 is formed with a notch 812. When the movable lock core 810 is rotated to a certain angle, by means of the notch 812, the movable lock core 810 avoids touching the driving rod 710. Therefore, a displaceable space 78 is defined between the movable lock core 810 and the driving rod 710.

Accordingly, when the numeral unlocking unit 71 is turned to an unlocking number, the movable hook 80 can be inward pressed in an unlocking direction. At this time, the driving rod 710 can be resiliently displaced with the movable hook 80. Reversely, when the numeral unlocking unit 71 is in a locked state, the driving rod 710 cannot be displaced to unlock the hanging lock. However, when a key is inserted to rotate the movable lock core 810 of the key-unlocked unit 81, the notch 812 can be moved to a position where the movable lock core 810 avoids touching the driving rod 710. At this time, the movable hook 80 can be still displaced to unlock the hanging lock without being stopped by the driving rod 710. Therefore, the hanging lock is double-unlockable.

The above embodiments are only used to illustrate the present invention, not intended to limit the scope thereof. Many modifications of the above embodiments can be made without departing from the spirit of the present invention.

1. An interlocked double-unlockable lock apparatus comprising:
a lock body;
a locking member disposed on the lock body; and
at least two unlocking modules, any of the at least two unlocking modules being able to drive the locking member to unlock the lock apparatus, the at least two unlocking modules being at least partially interlocked with each other in a locked state, and when any of the at least two unlocking modules is unlocked, the two at least two unlocking modules are released from each other to unlock the lock apparatus.

2. The interlocked double-unlockable lock apparatus as claimed in claim 1, wherein: the locking member is a teeterboard latch plate disposed on a female fastener, a numeral unlocking unit being disposed on the latch plate for pushing a movable member disposed on the latch plate, the movable member being supported by a support member disposed on a seat body, whereby the movable member cannot be pressed down to unlock the lock apparatus, when the numeral unlocking unit is in an unlocked state, the movable member is released from restriction of the support member to form one of the unlocking modules, a key-unlocked unit being disposed on the female fastener, such that, when the key-unlocked unit is in an unlocked state, the support member is displaceable to release the movable member so as to form another unlocking module.

3. The interlocked double-unlockable lock apparatus as claimed in claim 2, wherein the key-unlocked unit comprises a lock core seat, and a locating block, an outer end of the lock core seat being formed with a key hole, an inner end of the lock core seat having a lock core coupled with one end of the support member for controlling rotation of the support member another end of the support member being pivotally connected with the locating block.

4. The interlocked double-unlockable lock apparatus as claimed in claim 2, wherein the numeral unlocking unit comprises a numeral wheel set and a driving rod driven and controlled by the numeral wheel set, the driving rod being resiliently extensibly fitted in the numeral wheel set, a press end of the driving rod resiliently extending out from a hole of a lock casing, the movable member touching the press end, whereby the movable member is controlled between unlocking/locking states.

5. the interlocked double-unlockable lock apparatus as claimed in claim 2, wherein the movable member has a push plate, whereby one end of the push plate is engaged on the support section of the support member.

6. The interlocked double-unlockable lock apparatus as claimed in claim 2, wherein the movable member has an abutting post extending toward the press end of the driving rod for pushing the press end.

7-14. (canceled)
